(19) United States
(12) Patent Application Publication
(10) Pub. No.: US 2018/0194487 A1
(43) Pub. Date: Jul. 12, 2018

(54) OPTICAL DETECTOR FOR ENCOUNTER WITH DEBRIS SUSPENSION CLOUD

(71) Applicant: General Electric Company, Schenectady, NY (US)

(72) Inventors: Peter Andrew FLYNN, Delmar, NY (US); John Erik HERSHEY, Ballston Lake, NY (US); Radislav Alexandrovich POTYRAILO, Niskayuna, NY (US); Michael J DELL'ANNO, Clifton Park, NY (US)

(21) Appl. No.: 15/401,394

(22) Filed: Jan. 9, 2017

(51) Int. Cl. B64D 45/00; B64D 47/08; G06K 9/38; G06K 9/46

(52) U.S. Cl. CPC B64D 45/00; G06K 9/4661; G06K 9/38; B64D 47/08

(57) ABSTRACT

A system includes an image capture device within an existing aircraft shell having a turbine or a rotary wing, the image capture device including an optical assembly having a field of view directed towards at least one of the turbine, the rotary wing, and a surface of the aircraft shell, the image capture device configured to capture an image of radiant flux, and an image analysis unit in communication with the image capture device to analyze the captured radiant flux image to determine a particulate matter concentration in a debris suspension cloud. The system can also include a quantizer unit to quantize an electrical signal from the image capture device, the electrical signal proportional to an intensity of the radiant flux, and an integrator unit to obtain an about continuous value of the radiant flux intensity. A method to implement the system and a non-transitory computer-readable medium are also disclosed.

### BACKGROUND

Damage to a turbine can occur if it ingests debris suspended in the air flowing through the turbine. The debris suspension can erode and/or abrade the compressor blades and vanes. If the debris becomes molten due to its interaction with the turbine, it could block cooling holes and accelerate thermal fatigue of the turbine's component(s). Additionally, if the debris should solidify on the nozzle guide vanes, the gas flow path may be significantly impeded. This impediment can cause the turbine to produce less work resulting in inadequate drive to the compressor, which could result in a gas flow reversal and compressor surge.

Debris suspension clouds are often not visually perceptible by an aircraft pilot at night. The suspended particulate matter often does not have a large enough radar cross section to provide a sufficient echo for detection by onboard weather radars. During daylight, the pilot might see the debris suspension cloud but could misinterpret it as a water vapor cloud that poses no danger to the aircraft.

A debris suspension can be caused by multiple sources. For example, volcanic activity, dust, ash, sandstorm, dry environment, aircraft ground effect, air pollution, industrial chemical release, etc. Some of these sources can result in debris suspension clouds at lower altitudes and/or localized effects. Other sources (e.g., volcanic activity) can cause debris suspension clouds to rise tens of thousands of feet and to travel with prevailing winds over large swaths of the atmosphere. The size of the particles in the ash cloud will diminish in size as the cloud travels downwind.

Ingestion of debris can be an extreme safety hazard (an aircraft could lose all engine power). There can also be direct and indirect economic damages wrought by aircraft ingestion of debris. Debris can accelerate maintenance/repair schedules. An indirect cost can be the rerouting and cancellation of flights. For example, the 2010 eruption of the Icelandic volcano Eyjafjallajökull caused a significant closure of European airspace for a week. On the order of 100,000 flights were canceled with an estimated cost to the aviation industry of $2.6 billion.

Volcanic ash remains the largest source of debris suspension clouds encountered by aircraft. There are many conventional approaches to alert airborne flight crews to avoid volcanic ash clouds. For example, the International Civil Aviation Organization operates nine Volcanic Ash Advisory Centers monitoring volcanic ash plumes. This information provides only limited use to pilots and/or flight control centers. Conventional models based on prevailing wind patterns can track the likely path of the bulk of the ash/silica/ejecta, but these models are not accurate because ash scattering is highly uncertain. Thus, these models at best only approximate where the majority of the ash is likely to be going or to have gone, and leaves potentially large pockets of ejecta that might fall outside the predicted ranges/zones due to shifting winds and/or inaccuracies in flow models, particle sizes and altitude ranges.

Another conventional approach simply draws a radius around a volcanic eruption site that increases with time elapsed since eruption. Given a pre-determined confidence interval (say 95% or 99.7% for example), a traffic re-route zone can be maintained. The problem is that the circle radius can be overly large, where distance from an eruption site does not necessarily decrease the magnitude or impact of an ash ingestion event since even at a great distance, the concentration of ash could be very large, depending on dispersion patterns.

Establishing large radius keep-out zones is not a favorable outcome for a number of reasons—regions within the keep-out zone will be inaccessible entirely; flight routes that would normally traverse the keep out zone can become longer requiring more fuel; and potentially the rerouted flight path could exceed the aircraft range.

Conventional airborne monitoring approaches are directed towards examining specific operating parameters of the engine performance and identifying particulate composition and flow rate from changes in engine performance. Other approaches monitor airborne particulate matter and alert the flight crew to their presence. One conventional approach includes an infrared camera mounted on an exterior wing surface to detect volcanic ash day or night at long distances.

There is a need for a system that directly discerns an aircraft's presence in a debris suspension cloud. There is a need for this system to be installed within the aircraft, thereby eliminating the need for certification of skin-altering additions to the airframe.

### BRIEF DESCRIPTION OF THE DRAWINGS

FIG. 1 depicts the optical spectrum of the radiant flux generated by St. Elmo's fire;

FIG. 2 depicts a system for observing generated radiant flux in accordance with embodiments;

FIG. 3 pictorially depicts the system of FIG. 2 located within an airframe in accordance with embodiments;

FIG. 4 pictorially depicts a secondary turbine inlet positioned in proximity to a turbine inlet in accordance with embodiments;

FIG. 5 depicts the system of FIG. 2 including components to quantify wear of turbine blades in accordance with embodiments;

FIG. 6 depicts data curves illustrating various infrared signature factors as a function of particulate matter injection in accordance with embodiments;

FIG. 7 depicts a flowchart of a process for quantifying particulate matter injection into an engine in accordance with embodiments;

FIG. 8A diagrammatically depicts aborted flights when no false positives are reported by a system in accordance with embodiments;

FIG. 8B diagrammatically depicts aborted flights when some false positives are reported by a system in accordance with embodiments; and

FIG. 9 depicts a flowchart of a process for applying reports generated by the system of FIG. 2 and the method of FIG. 7 in accordance with embodiments.

### DETAILED DESCRIPTION

Embodying systems and methods directly discerns an aircraft's presence in a debris suspension cloud. Embodying systems can include an electronic camera that provides a digital image to a signal processor that operates to detect the onset of radiant flux caused by an aircraft entering a debris suspension cloud. Embodying systems and methods can provide a near-instantaneous warning of the situation. In accordance with embodiments, system components can be located within the existing shell of the aircraft, with the camera positioned to view through an existing window or aperture—i.e., not attached to the aircraft outer skin, nor needing the creation of an optical via through the outer skin. Thus, implementing this system into new aircraft builds, and retrofit installations, should not require flightworthiness certification of the aircraft. Embodying systems and methods provide a direct discernment system that can detect the actual presence of a debris suspension cloud around and/or near a turbine without relying on the conventional approach of applying an overly-inclusive model based on a likelihood of occurrence derived from estimations of exposure.

St. Elmo's fire is a weather phenomenon in which can result from a corona discharge from a surface with a high radius of curvature, such as a pointed object, in the presence of a strong electric field. This discharge can produce a visible, light-emitting radiant flux with an observed color range of bright blue or violet.

Whether an aircraft is transiting a debris suspension cloud of volcanic ash, or non-volcanic ash, can be determinative in where the St. Elmo radiant flux manifests itself. In accordance with embodiments, this distinction can be used to identify the nature of the suspension's particulate matter.

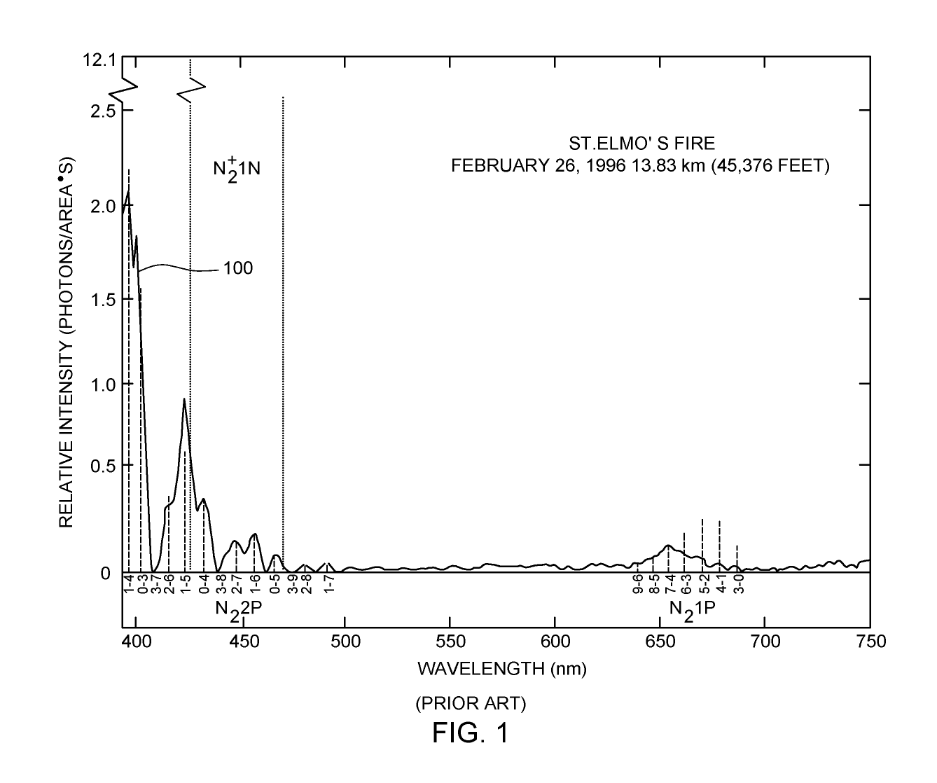

FIG. 1 depicts an observed optical spectrum 100 of St. Elmo's fire on an aircraft flying at about 45,000 feet. The observations were recorded by a spectrograph aimed at the aircraft's wing and nose. The researchers making these observations were not transiting a cloud hosting volcanic ash, and there was no report of a deleterious effect on the aircraft.

Experiments assessing the impact of dust-laden air on turbine aircraft engines reports that an observable glow appears at the fan face of a turbofan engine, or at the compressor face of a turbojet engine. This glow is attributable to St. Elmo's fire (i.e., radiant flux), and is indicative of dust suspension in the environment.

Downward thrust of a rotary wing aircraft (e.g., a helicopter, a vertical take-off and landing (VTOL) aircraft, etc.) can generate a local debris suspension cloud. Other sources of debris suspension clouds can include air pollution, industrial chemical release, etc. The debris suspension cloud, regardless of its source, can cause an observable radiant flux generated on turbine components transiting the cloud (e.g., aircraft, wind generation plant, locomotive engine, etc.).

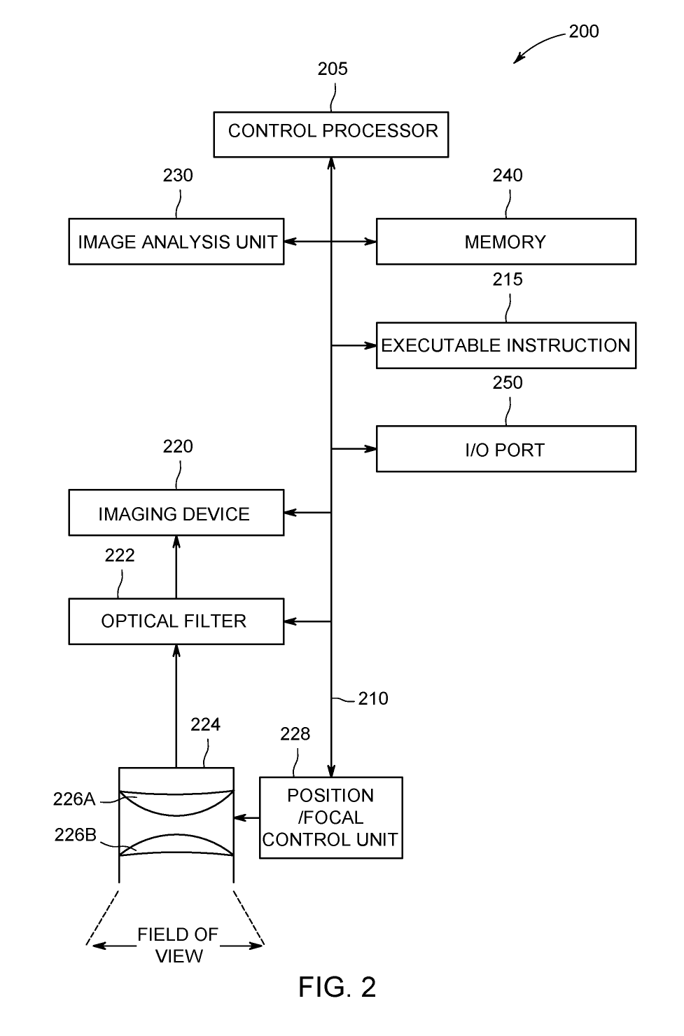

FIG. 2 depicts system 200 for observing generated radiant flux in accordance with embodiments. The radiant flux can be caused by a buildup of electrostatic charge between the suspended debris particles and metallic surfaces moving through the debris suspension cloud. This radiant flux can be generated on, for example, turbine components (or aircraft frame components) passing through a debris suspension cloud.

System 200 can include control processor 205 that executes executable instructions 215 to control other units of the system. The control processor can be in communication the components of system 200 across data/communication bus 210.

System 200 can include optical assembly 224 that can contain one or more optical lenses 226A, 226B. In accordance with embodiments, the field-of-view (FOV) of optical assembly 224 can be adjusted by position/focal control unit 228 by control of servos, encoders, and the like. Control unit 228 can change the relative position of the lenses to increase/decrease the field-of-view so that a particular portion of a turbine and/or aircraft frame can be observed by system 200. Control unit 228 can also change the position of the optical assembly so that a different portion of the turbine and/or airframe is within the FOV. Control processor 205 can control position/focal control unit 228 by executing instructions 215.

Optical assembly 224 can provide an image to optical filter 222. Optical filter 222 can be matched to pass, with minimum attenuation, at least a portion of the light spectrum emitted by the radiant flux. The optical filter would attenuate light frequencies outside the radiant flux spectrum. In accordance with embodiments, optical filter 222 can be adaptively controlled by control processor 205 to change the optical filter's band pass characteristics to match light spectrum emissions from different particulate matter (e.g., volcanic ash, pollution, ground effect dust, etc.) that could be within the debris suspension cloud. Examples of the optical filter band pass characteristics can include, but are not limited to, the maximum percent transmission at the center of the band-pass of the filter; the light frequency (wavelength) of the center of the band-pass of the filter; the width of the band-pass of the filter; the steepness of the band-pass of the filter; and the existence of undesired or desired side band pass regions of the optical filter. The optical filter may have its band pass characteristics in the ultraviolet, visible, or infrared spectral regions.

A filtered, captured image is provided to imaging device 220. Imaging device 220 can be a solid-state electronic camera that creates a digital image. This digital image can be provided to image analysis unit 230 and/or stored in memory 240.

Image analysis unit 230 can be implemented as a signal processing unit configured to detect the onset of radiant flux generation caused by entering a debris suspension cloud. In accordance with embodiments, imaging device 220 can create digital images at a predetermined (fixed or variable) rate and provide the images to the image analysis unit. Analysis of a stream of images can provide details on whether radiant flux is being generated.

The intensity of the radiant flux glow can be linked nearly linearly to the concentration of particulate matter within the debris suspension cloud. The light can also be a function of the speed of the metal component (turbine blade, wing leading edge, etc.) passing through the debris suspension cloud. The intensity of the light positively correlates with the particulate density; i.e. the denser the debris suspension the stronger the maximum light intensity.

In accordance with embodiments, the detection of increased radiant flux generation can cause the image capture rate to increase. In this manner, about instantaneous detection of the presence of a debris suspension cloud can be determined. When a debris suspension cloud is detected, and the severity of the radiant flux generation indicates a critical concentration of particulate matter (i.e., above a predetermined threshold) for turbine operation, a warning signal can be provided by input/output (I/O) port 250 to operators (flight crew, locomotive engineers, power generation personnel, etc.).

In accordance with embodiments, analysis results can be uploaded via I/O port 250 across an electronic communication network to a remote server. The data can be uploaded on a real time or near real-time basis to the remote server for storage in a data store in communication with the remote server. The remote server can execute instructions to review data records of volcanic flashes obtained from meteorological observation equipment to correlate the analysis from system 200 with known conditions. A verification report can be communicated back to the flight crew.

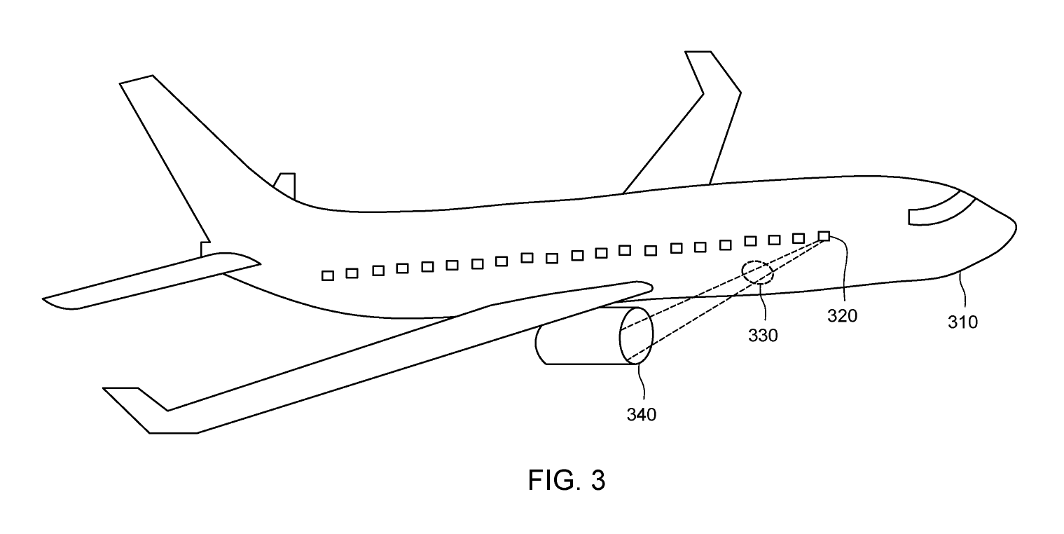

FIG. 3 pictorially depicts system 200 located within airframe (or “aircraft shell”) 310 in accordance with embodiments. Location within the aircraft would not require outside mounting hardware, nor an optical via through the outer skin of the aircraft. In accordance with embodiments, optical assembly 224, and all other components of system 200, are located behind window 320 of airframe 310. The optical assembly is positioned, and focused, such that field of view 330 is pointed at engine face 340.

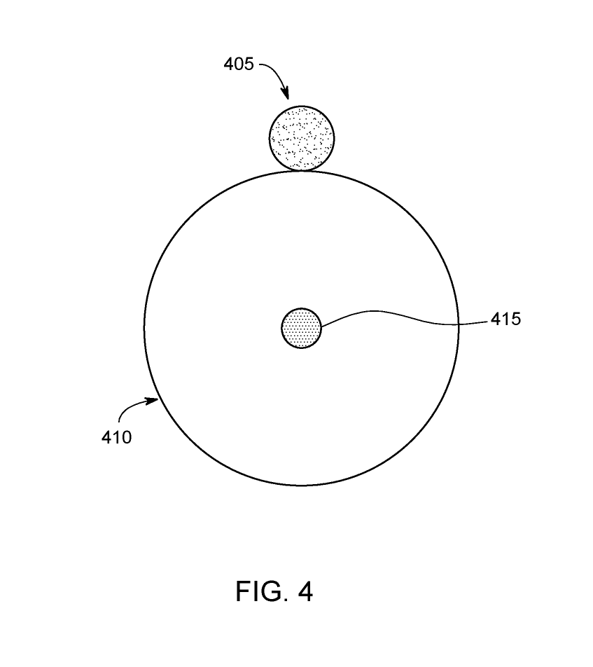

FIG. 4 depicts secondary turbine inlet 405 positioned in proximity to main turbine inlet 410 in accordance with embodiments. FIG. 4 is a pictorial front view and includes the turbine hub 415 for reference. The position of secondary turbine inlet 405 is selected so that the secondary inlet is exposed to the same debris suspension cloud density as the main turbine inlet 410. In accordance with embodiments secondary turbine inlet 405 is smaller than the main turbine inlet. The secondary inlet is placed in proximity to the main inlet 410 to induce electrostatic charges. In accordance with embodiments, the secondary turbine can include either a motor driven turbine, or a ram air driven turbine [not shown]. The turbine blades of either implementation would spin causing generation of the St. Elmo's fire effect more readily than the larger orifice of the main turbine.

The optical assembly 224 (FIG. 2) can be focused on secondary inlet 405 rather than the main inlet. Because of the smaller surfaces, and concentrated volume, monitoring the secondary inlet can act as an early warning system—i.e., the presence of a debris suspension cloud can be detected earlier, presumably before much has entered the main turbine inlet. Implementation of this embodiment on search and rescue helicopters can rely on visual cues from the generation of St. Elmo's fire on/in the secondary inlet to avoid debris suspension plumes. The helicopter crew can then be alerted of the need to evacuate the area before excessive particulate matter is ingested into the main turbine inlet.

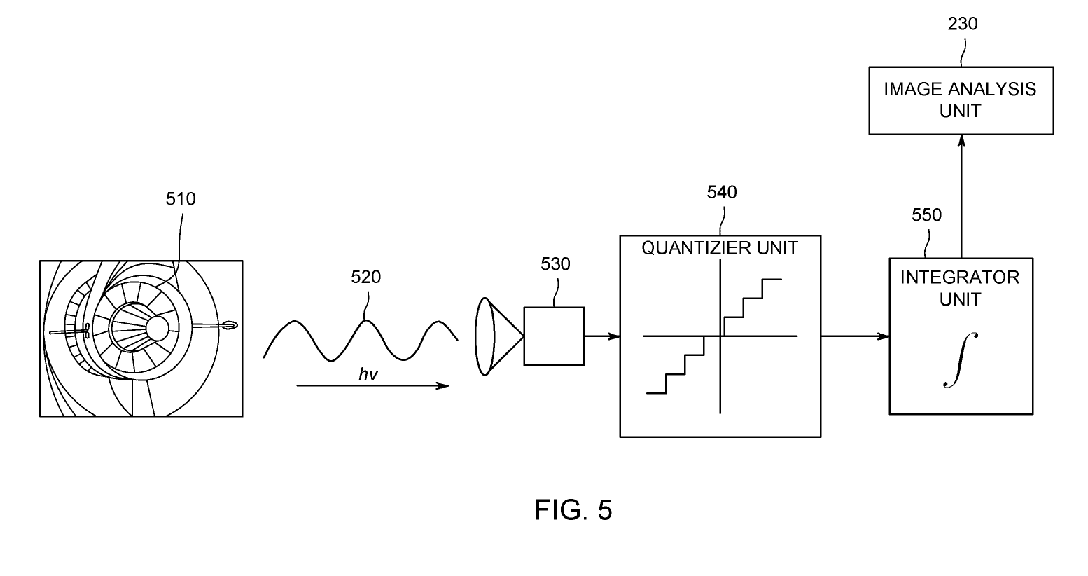

FIG. 5 depicts system 200 with the addition of quantizer unit 540 and integrator unit 550 to quantify wear of turbine, and or rotary wing, blades based on observed radiant flux in accordance with embodiments. Image capture device 530 can include optical lens(es) 226A, 226B, optical assembly 224, optical filter 222, and imaging device 220. The movement of turbine blades 510 through the particulate matter of a debris suspension cloud can produce radiant flux 520.

In accordance with embodiments, the radiant flux intensity of the light produced by interaction between the debris suspension cloud and moving turbine blades (or rotary wing, or airframe surface) can be integrated to provide a parameter that can be used to determine an amount of wear. The radiant flux produced is expected to be nearly linearly linked to the debris suspension particulate matter concentration, a function of turbine blade speed, and blade composition. The quantifiable relationships are derivable from measured data produced by an experiment quantifying the intensity of glow generated by a buildup of electrostatic charge on particulate matter of the debris suspension cloud, and/or on the moving surfaces of the turbine blades.

With regard to FIG. 5, image capture device 530 can convert the intensity of the observed radiant flux to an electrical signal proportional to the camera-observed radiant flux. The electrical signal is quantized by a quantizer unit 540 and the quantized value integrated by integrator unit 550. The integrated value produced by the integrator 550 may function as a parameter of about continuous value representative of the radiant flux intensity in a series of captured digital images. This about continuous value of radiant flux intensity can be used to quantify an amount of wear. The output of integrator 550 can be provided to image analysis unit 230 for analysis to determine the amount of wear.

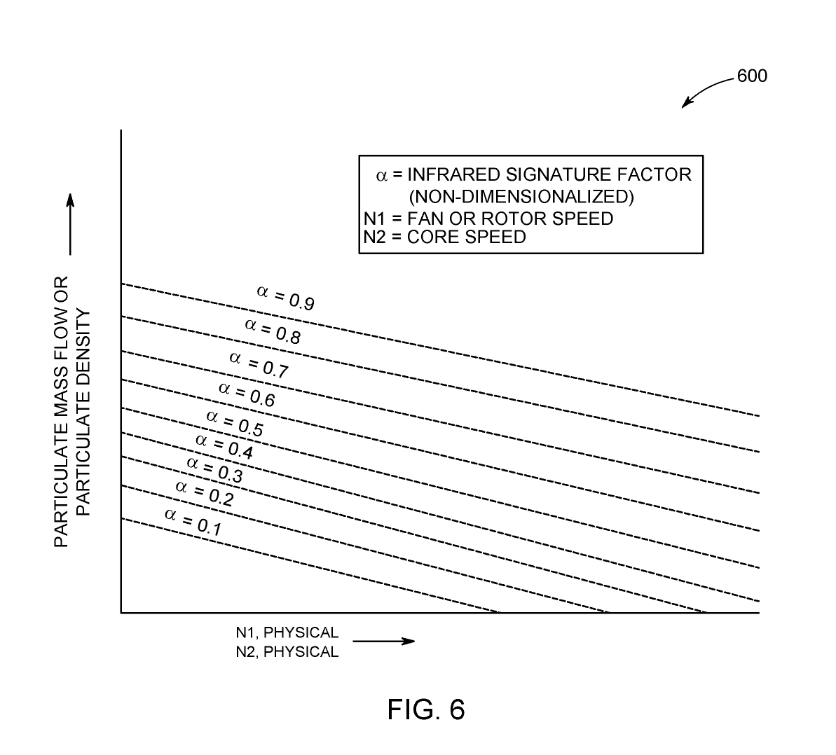

FIG. 6 depicts data curves 600 illustrating various infrared signature factors (a) as a function of particulate matter injection in accordance with embodiments. The infrared signature factor curves can be used by image analysis unit 230 in quantifying the wear on the turbine blades.

The infrared signature is a function of both the mass flow of particulate matter entering the engine, as well as the kinetic forces of the fan or rotor blade (which, for example, in turn is a function of physical fan/rotor speed N1, or core speed N2). Engine or application-specific curves can be derived experimentally in a test cell environment, or empirically using flight data. The rate of engine health deterioration can have a strong correlation with the mass flow of ingested particulate matter. The mass flow of ingested particulate matter may be approximated from these curves, using the infrared signature factor and the fan, rotor or core speed. The use of the proposed system and infrared signature provides an additional source of engine health data that has previously been unavailable. Embodying systems and methods improve estimations of engine deterioration rate by assessing an infrared signature and/or approximated mass flow of particulate matter integrated over time.

In accordance with embodiments, the approximation of particulate matter injection into an engine (or alternatively, particulate density in the vicinity of a rotary wing) can be refined using the fan speed, core speed, or rotor speed as appropriate. For example, the infrared signature factor increases for either a constant particulate level (constant y-axis) as the rotational speed increases, or for a constant rotational speed (constant x-axis) as the particulate level increases.

Rotor and fan blade scintillation is driven by (1) the particulate mass flow into the fan of an engine (or alternatively, particulate density in the vicinity of a rotary wing); (2) the inertial or kinetic forces (i.e., “collisional” forces) caused by the fan or rotor blades (or compressor and/or booster blades) hitting or colliding with the particulate matter; and (3) a low humidity environment. Humidity measurement at the low end of the spectrum is not very accurate; nor are humidity measurements generally available on aircrafts. Furthermore, because scintillation is likely to only occur in dry environments, the range of relative humidity experienced during scintillation is relatively narrow. Accordingly, refining the approximation of particulate matter based on humidity can be omitted.

Fan, rotor, and/or core speed are all readily available on-wing and act as a proxy for kinetic, inertial and/or collisional forces. In accordance with implementations, the physical, uncorrected fan, rotor, and/or core speed provides an improved approximation because the interaction between the fan, rotor, and/or compressor blades and the particulate matter is not dependent on how much energy was required to achieve the speed (due primarily to the effect on ambient temperatures). The interaction is primarily based on the actual kinetic energy level at the time of impact. Therefore, using a “corrected speed” could skew this approximation. Thus, given the fan, core, and/or rotor speed and the infrared signature of the scintillation, the mass flow of ingested particulate matter can be approximated.

In accordance with embodiments, optical assembly 224 can be implemented as an infrared camera. The infrared camera can be placed within a bypass duct or engine core compartment of a turbine. The infrared camera can sense compressor blade scintillation within the engine. Placement within the bypass duct or engine core would lessen the impact that visible light has on the infrared scintillation signature due to the camera being directed at an area within a generally dark compartment. In accordance with some embodiments, the image provided by the infrared camera could be used to intermittently detect the presence of ice buildup within the bypass duct in the under-cowling or other locations where ice is likely to accumulate.

In accordance with embodiments, multiple infrared cameras can be utilized, with each of the multiple infrared cameras calibrated to sense different infrared signature ranges. For example, a first infrared camera could be calibrated in a range that senses and quantifies the amount of particulate matter ingested by an engine in a “normal” or “daily” scenario. A second infrared camera could be calibrated for a much larger range to sense and quantify the amount of particulate matter ingested during a sandstorm, volcanic ash event, and\or other type of atypical or unusual situation.

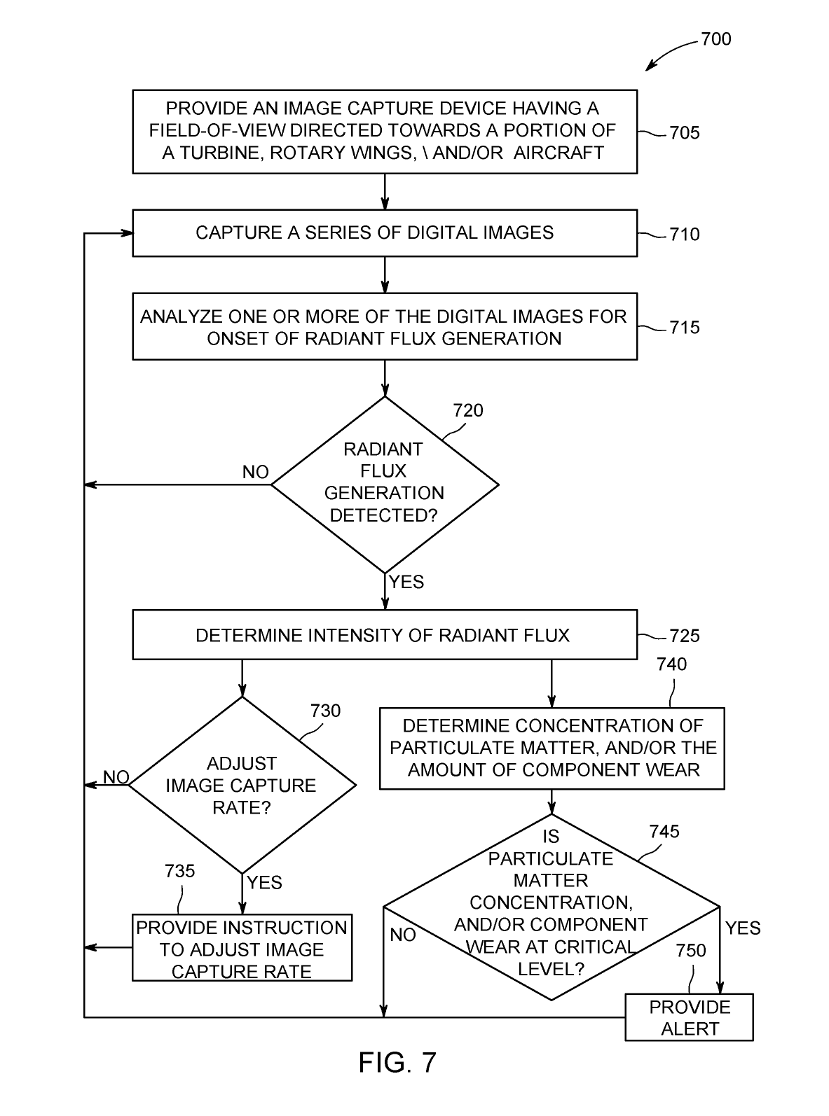

FIG. 7 depicts a flowchart of process 700 for quantifying particulate matter injection into an engine in accordance with embodiments. An image capture device is provided, step 705. In accordance with embodiments, the image capture device can include optical lens(es) 226A, 226B, optical assembly 224, optical filter 222, and imaging device 220. In some implementations the image capture device can convert an observed radiant flux to a proportional electrical signal by inclusion of quantizer unit 540 and integrator unit 550.

The image capture device can be mounted internal to an airframe to eliminate external mounting hardware or an optical via through the airframe. The field-of-view of the image capture device is directed towards a portion of a turbine, a rotary wing, or the aircraft. Interaction between moving metal members of these components and a debris suspension cloud can cause generation of a radiant flux.

A series of digital images are captured, step 710, by the image capture device. These images can be obtained at regular and/or irregular intervals based on the concentration of particulate matter in the debris suspension cloud, the geographic location of the aircraft, and/or other considerations. The captured images can be provided to image analysis unit 230, which analyzes, step 720, the images.

If the analysis result indicates that a radiant flux is not detected, the process returns to step 710, where images are continued to be captured. If a radiant flux is detected, the intensity of the radiant flux is determined, step 725. The intensity of the light positively correlates with the particulate density—i.e. the denser the debris suspension the stronger the maximum light intensity.

The image capture rate can be adjusted, step 730, based on the radiant flux intensity. For example, if the intensity is greater than a threshold and/or is increasing compared to prior readings, then the capture rate could be increased. Otherwise, the capture rate can be decreased, until some later reading indicates an increasing concentration of particulate matter. Instruction to adjust the capture rate can be provided, step 735, by control processor 205 to the image capture device.

The concentration of particulate matter based on the intensity of the radiant flux, and/or the amount of component wear, or deterioration, based on the proportional integrated signal can be determined, step 740. If the particulate concentration, and/or the component wear (i.e., above a predetermined tolerance) is at a critical level, step 745, an alert can be provided, step 750. If not, then the process can continue capturing digital images (step 710). The alert can be in the form of a cockpit annunciator and/or display to the crew. In some implementations the alert can be transmitted to tracking stations, or broadcast to other aircraft.

Embodying systems and methods provide both safety and economic benefits, even if the system yields an acceptable number of false positives. For example, because embodying systems and methods determine flight status on actual conditions experienced by the aircraft, the number of aborted flights is reduced when compared to the conventional approach of aborting flights based on an assumptive prediction of where a debris suspension cloud might exist.

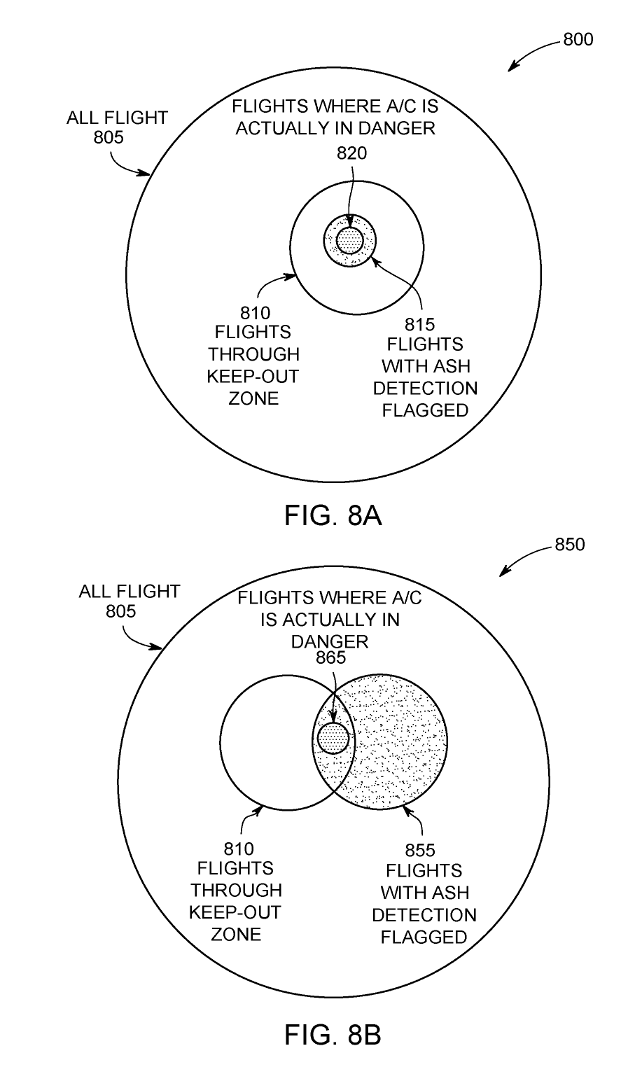

FIG. 8A diagrammatically depicts flights aborted when no false positives are reported by a system in accordance with embodiments. Venn diagram 800 is representative of all aircraft flights 805 using an embodying system that reports no false positives (i.e., all reports of the presence of a debris suspension cloud are accurate). Flights 810 are representative of flights traversing a keep-out zone determined by conventional approaches based on, for example, meteorological predictions. Flights 815 are those flights where system 200 determines the presence of a debris suspension cloud. Only flights 820 (a subset of flights 815) are representative of being within a debris suspension cloud of sufficient concentration to harm the aircraft. It is flights 820 that would be flagged to be aborted based on reports generated by embodying systems and methods. Conventional approaches would flag all flights 810 within the keep-out zone to be aborted.

FIG. 8B diagrammatically depicts flights aborted when some false positives are reported by a system in accordance with embodiments. Venn diagram 850 is representative of all aircraft flights 805 using an embodying system that reports occasional false positives (i.e., an occasional report of the presence of a debris suspension cloud is not accurate). Flights 810 still represents those flights traversing a keep-out zone determined by conventional approaches based on, for example, meteorological predictions. Flights 855 are those flights where system 200 determines the presence of a debris suspension cloud, including those flights flagged by false positives. Because in this example, system 200 reports occasional false positives, the quantity of flights 855 is larger than the quantity of flights 815. Only flights 865 (a subset of flights 855) are representative of being within a debris suspension cloud of sufficient concentration to harm the aircraft. It is flights 865 that would be flagged to be aborted. Conventional approaches would flag all flights 810 within the keep-out zone to be aborted. As illustrated by Venn diagrams 800, 850 embodying systems and methods result in far fewer flights being aborted, even with an occasional false positive report.

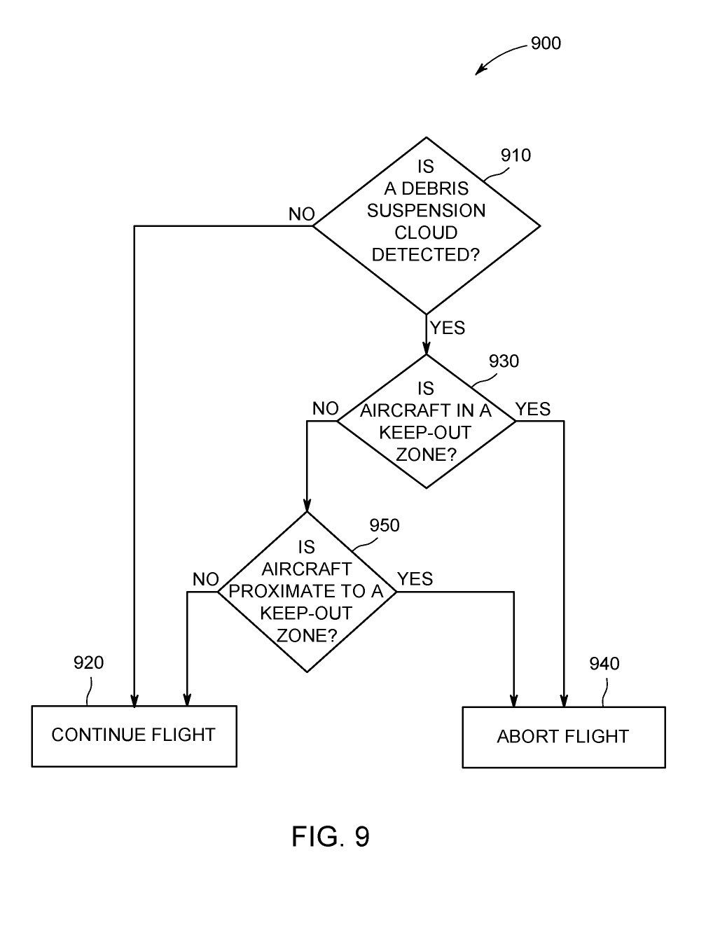

FIG. 9 depicts process 900 for applying reports generated by embodying systems and methods in accordance with embodiments. A decision is made determining whether a debris suspension cloud is detected, step 910. If a debris suspension cloud is not detected, the flight continues, step 920. If a debris suspension cloud is detected, a determination is made whether the aircraft is currently traversing a keep-out zone, step 930. If the aircraft is traversing a keep-out zone, the flight is aborted, step 940. In this manner, the safety of the passengers, crew, and aircraft flight worthiness are all secured.

If the aircraft is not traversing a keep-out zone, at step 950 a decision is made determining whether the aircraft is proximate to a keep-out zone. The distance from the keep-out zone in determining step 950 can be predetermined by aviation authorities, the flight crew, aircraft maintenance recommendations, or by other criteria. If the aircraft is determined not to be proximate to the keep-out zone, the flight continues, step 920. If the aircraft is determined to be proximate to the keep-out zone (within the predetermined distance), the flight is aborted, step 940.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as a method for detecting the presence of a debris suspension cloud, as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A system comprising:
an image capture device located within an existing aircraft shell;
at least one of a turbine and rotary wing attached to the existing aircraft shell;
the image capture device including an optical assembly having a field of view directed towards at least one of the turbine, the rotary wing, and a surface of the aircraft shell, the image capture device configured to capture an image of radiant flux; and
an image analysis unit in communication with the image capture device, the image analysis unit configured to analyze the captured radiant flux image to determine a particulate matter concentration in a debris suspension cloud.

2. The system of claim 1, the image capture device including an optical lens, an optical filter, and an imaging device.

3. The system of claim 1, including:
a quantizer unit in communication with the image capture device, the quantizer unit configured to quantize an electrical signal from the image capture device, the electrical signal proportional to an intensity of the radiant flux; and
an integrator unit configured to integrate the quantized electrical signal to obtain an about continuous value representative of the radiant flux intensity.

4. The system of claim 3, including the image analysis unit configured to determine an amount of wear on a surface of at least one of the turbine, the rotary wing, and the aircraft shell surface based on the about continuous value.

5. The system of claim 4, including a control processor in communication with components of the system across a data/communication bus, the control processor configured to execute instructions that cause the control processor to generate an alert if the surface wear is above a predetermined tolerance.

6. The system of claim 1, including a position/focal control unit configured to adjust at least one of a position and the field of view of the optical assembly.

7. The system of claim 1, including the image capture device configured to capture a series of radiant flux images at a predetermined rate, the predetermined rate adjustable based on an intensity of a captured radiant flux image.

8. The system of claim 1, including a control processor in communication with components of the system across a data/communication bus, the control processor configured to execute instructions that cause the control processor to generate an alert if the particulate matter concentration is above a predetermined threshold.

9. The system of claim 2, including the optical filter configured to be adaptively controlled to change band pass characteristics to match light spectrum emissions from different particulate matter.

10. A method comprising:
capturing, at a first sampling rate, digital images of at least one of a turbine, a rotary wing, and an aircraft shell, the digital images captured by an image capture device located within the aircraft shell;
analyzing the digital images for radiant flux generation, the radiant flux caused by an interaction between particulate matter in a debris suspension cloud and at least one of the turbine, the rotary wing, and the aircraft shell;
if radiant flux is detected, then determining an intensity of the radiant flux; and
if radiant flux is not detected, continuing capturing digital images.

11. The method of claim 10, including:
quantizing an electrical signal from the image capture device, the electrical signal proportional to an intensity of the radiant flux;
integrating the quantized electrical signal to obtain an about continuous value representative of the radiant flux intensity;
determining an amount of wear on a surface of at least one of the turbine, the rotary wing, and the aircraft shell surface; and
generating an alert if the amount of wear is above a predetermined tolerance.

12. The method of claim 10, including:
determining the radiant flux intensity;
correlating the radiant flux intensity to a concentration of particulate matter in the debris suspension cloud; and
generating an alert if the particulate matter concentration is above a predetermined threshold.

13. The method of claim 12, including adjusting the first sampling rate to a second sample rate based on the radiant flux intensity.

14. The method of claim 10, including adjusting one of a position and a field of view of the image capture device to capture alternate areas of the turbine, the rotary wing, and the aircraft shell.

15. The method of claim 10, including changing band pass characteristics of an optical filter to match light spectrum emissions from different particulate matter

16. A non-transitory computer readable medium containing computer-readable instructions stored therein for causing a control processor to perform a method comprising:
capturing, at a first sampling rate, digital images of at least one of a turbine, a rotary wing, and an aircraft shell, the digital images captured by an image capture device located within the aircraft shell;
analyzing the digital images for radiant flux generation, the radiant flux caused by an interaction between particulate matter in a debris suspension cloud and at least one of the turbine, the rotary wing, and the aircraft shell;
if radiant flux is detected, then determining an intensity of the radiant flux; and
if radiant flux is not detected, continuing capturing digital images.

17. The non-transitory computer readable medium of claim 16 containing computer-readable instructions stored therein to cause the control processor to perform the method including:
quantizing an electrical signal from the image capture device, the electrical signal proportional to an intensity of the radiant flux;
integrating the quantized electrical signal to obtain an about continuous value representative of the radiant flux intensity;
determining an amount of wear on a surface of at least one of the turbine, the rotary wing, and the aircraft shell surface; and
generating an alert if the amount of wear is above a predetermined tolerance.

18. The non-transitory computer readable medium of claim 16 containing computer-readable instructions stored therein to cause the control processor to perform the method including:
determining the radiant flux intensity;
correlating the radiant flux intensity to a concentration of particulate matter in the debris suspension cloud; and
generating an alert if the particulate matter concentration is above a predetermined threshold.

19. The non-transitory computer readable medium of claim 18 containing computer-readable instructions stored therein to cause the control processor to perform the method including adjusting the first sampling rate to a second sample rate based on the radiant flux intensity.

20. The non-transitory computer readable medium of claim 16 containing computer-readable instructions stored therein to cause the control processor to perform the method including adjusting one of a position and a field of view of the image capture device to capture alternate areas of the turbine, the rotary wing, and the aircraft shell.
